(19) United States
(12) Patent Application Publication
(10) Pub. No.: US 2012/0089516 A1
(43) Pub. Date: Apr. 12, 2012

(54) Method and system of processing financial transaction

(75) Inventors: WeiCheng Tian, Shanghai (CN); Yi Dong, Shanghai (CN)

(73) Assignee: ONBEST TECHNOLOGY HOLDINGS LIMITED

(21) Appl. No.: 12/924,917

(22) Filed: Oct. 8, 2010

(51) Int. Cl. G06Q 40/00; G06Q 20/00

(52) U.S. Cl. 705/44; 705/39; 235/380; 235/379

(57) ABSTRACT

A system for processing financial transaction includes two or more financial transaction devices, a management control linked with a financial institution network, and a financial transaction network linking the financial transaction devices with the management control, wherein the financial transaction devices are communicatively linked with each other. The financial transaction devices of a payer and a payee respectively obtain financial information of the payer and the payee. The financial information of the payer, the financial information of the payee, and payment amount of the financial transaction are consolidated in the financial transaction device to generate payment information, which is sent together with a request for financial transaction by the financial transaction device to the management control. The management control transact the payment from an account of the payer regarding to the financial information thereof to an account of the payee regarding to the financial information thereof through the financial institution network for processing the financial transaction between the payer and the payee.

### BACKGROUND OF THE PRESENT INVENTION

1. Field of Invention

The present invention relates to a method and system of processing financial transaction between the payers and the payees, and more particularly to a method and system of processing financial in security without leaking confidential information.

2. Description of Related Arts

Purchasing is an exchanging activity happens every moment in daily life. In a purchase, there are two parties, the payer and the payee. The payer pays a predetermined amount of money to the payee in order to get a product or a service therefrom. The payer receives the money and provides the product or service to the payer to finish the transaction. Currently, there are three most common methods to pay the money to the payee: pay by cash, pay by check, and pay by credit card.

The disadvantage of paying cash is obvious. It is not convenient to carry a large amount of cash. At the same time, it is not safe. Check is not always acceptable because the payee can not verify it is payable. Therefore, credit card is the most favorite method to make a payment. The payer just needs to give his card information to the payee. The payee then verifies the payer's identification, and uses the card information provided by the payer to claim a mount of money from the payer's account in a credit card company.

The biggest problem of this method is that during the purchase, the payer is under an unfair and unprotected condition. The payer has to disclose his personal information to the payee. This information includes payer's name, date of birth, card information, etc, which is very sensitive. After disclosing, the payer then totally has no control on his information. This information can be abuse or stolen from the payee for illegal purposes and the payer has to bear the losses. While in many cases, the payer may not know or recognize the payee, so the payer doesn't have any control to protect his information.

Also, in most cases, credit card transaction is performed by a POS machine. The POS machined belongs to the payee and is totally under the payee's control. The payer has to approach to the payee for making payment. It is inconvenient and not safe.

Currently, more and more purchases are made through Internet. It is more risky to pay some online stores who are more unstable. There are some organizations providing online payment service. Payers make payment through these organizations that are more reliable than many other online stores. But still, the payer has to disclose his personal and sensitive information. More over, one more party is getting involved in a purchase which increases the cost and introduces more risk.

It is obvious the conventional methods of making payment in purchase need to be changed.

### SUMMARY OF THE PRESENT INVENTION

The invention is advantageous in that it provides a system and a method of processing financial transaction between the payers and the payees without leaking confidential information.

The invention is advantageous in that it provides a method of processing financial transaction between the payer and the payee, wherein the financial information is given by the payee to the payer for completing the transaction instead of the conventional method of giving the financial information from the payer to the payee to complete the transaction.

The invention is advantageous in that it provides a secured method of processing financial transaction, wherein the payer doesn't need to disclose his personal information to the payee to prevent the leak of confidential information of the payer.

The invention is advantageous in that it provides a secured method of processing financial transaction, which protects the personal information of the payer when the payer physically meets with the payee to proceed to a financial transaction.

The invention is advantageous in that it provides a secured method of processing financial transaction, wherein every piece of financial information is encrypted before sending out.

The invention is advantageous in that it provides a secured method of processing financial transaction, wherein when each financial transaction is requested, a password will be sent to a relative mobile phone and is required to complete the financial transaction, thereby the illegal financial transaction will be prevented.

The invention is advantageous in that it provides a secured method of processing financial transaction, wherein the financial transaction could be frozen or revoked with the request of the payer.

The invention is advantageous in that it provides a system for processing financial transaction between the payer and the payee, wherein the financial information is given by the payee to the payer when the payer physically meets with the payee for completing the transaction instead of the conventional method of giving the financial information from the payer to the payee to complete the transaction.

The invention is advantageous in that it provides a secured system for processing financial transaction, wherein the payer doesn't need to disclose his personal information to the payee to prevent the leak of confidential information of the payer.

The invention is advantageous in that it provides a secured system for processing financial transaction, which protects the personal information of the payer when the payer physically meets with the payee to proceed to a financial transaction.

The invention is advantageous in that it provides a secured system for processing financial transaction, wherein every piece of financial information is encrypted before sending out.

The invention is advantageous in that it provides a secured system for processing financial transaction, wherein when each financial transaction is requested, a password will be sent to a relative mobile phone and is required to complete the financial transaction, thereby the illegal financial transaction will be prevented.

The invention is advantageous in that it provides a secured system for processing financial transaction, wherein the financial transaction could be frozen with the request of the payer.

The invention is advantageous in that it provides a secured system for processing financial transaction, which is controlled by payer throughout the financial transaction.

The invention is advantageous in that it provides a financial transaction device for processing financial transaction, which also is a personal financial management device to organize and manage all the financial transaction by the payer.

The invention is advantageous in that it provides a financial transaction device for processing financial transaction, wherein the payer is able to select one or more financial institutions of the payment system to transact the payment to the payee through the device.

The invention is advantageous in that it provides a financial transaction device for processing financial transaction, which is portable for the payer to carry every where such that the device of the present invention is a replacement of credit card.

The invention is advantageous in that it provides a financial transaction device for processing financial transaction, which is convenient to use.

Additional advantages and features of the invention will become apparent from the description which follows, and may be realized by means of the instrumentalities and combinations particular point out in the appended claims.

According to the present invention, the foregoing and other objects and advantages are attained by a system for processing financial transaction, which comprises two or more financial transaction devices, a management control linked with a financial institution network, and a financial transaction network linking the financial transaction devices with the management control, wherein the financial transaction devices are communicatively linked with each other.

The financial transaction devices of a payer and a payee respectively obtain financial information of the payer and the payee. The financial information of the payer, the financial information of the payee, and payment amount of the financial transaction are consolidated in the financial transaction device to generate payment information, which is sent together with a request for financial transaction by the financial transaction device to the management control. The management control transact the payment from an account of the payer regarding to the financial information thereof to an account of the payee regarding to the financial information thereof through the financial institution network for processing the financial transaction between the payer and the payee.

In accordance with another aspect of the invention, the present invention comprises a method of processing financial transaction, comprising steps of:

(a) providing a financial transaction network and a management control;

(b) obtaining financial information of a payer and obtaining financial information of a payee;

(c) consolidating said financial information of said payer, said financial information of said payee and a payment amount of said financial transaction to generate a payment information;

(d) sending a request for financial transaction together with said payment information to said management control through said financial transaction network;

(e) transacting said payment from an account of said payer regarding to said financial information thereof to an account of said payee regarding to said financial information thereof through a financial institution network.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a system for processing financial transaction according to a preferred embodiment of the present invention.

FIG. 2 is a block diagram of a financial transaction device according to above preferred embodiment of the present invention.

FIG. 3 is a block diagram of a system for processing financial transaction according to another preferred embodiment of the present invention.

FIG. 4 is a flow chart of a method of processing financial transaction according to above preferred embodiment of the present invention.

### DETAILED DESCRIPTION OF THE PREFERRED EMBODIMENT

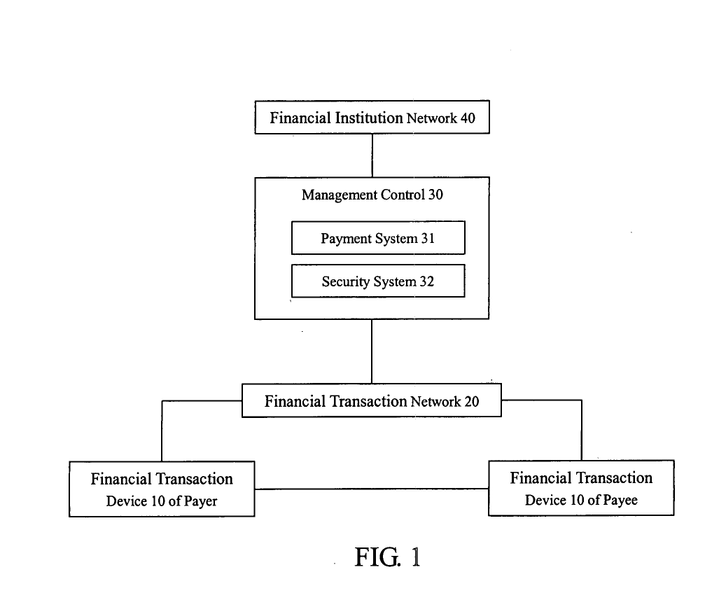

Referring to FIG. 1, a system for processing financial transaction according to a preferred embodiment of the present invention is illustrated, wherein the system for processing financial transaction comprises two or more financial transaction devices 10, a management control 30 linked with a financial institution network 40, and a financial transaction network 20 linking the financial transaction devices 10 with the management control 30, wherein the financial transaction devices 10 are communicatively linked with each other. The financial transaction devices 10 of a payer and a payee respectively obtain financial information of the payer and the payee. The financial information of the payer, the financial information of the payee, and payment amount of the financial transaction are consolidated in the financial transaction device 10 to generate a payment information, which is sent together with a request for financial transaction by the financial transaction device 10 to the management control 30, wherein the management control 30 transact the payment from an account of the payer regarding to the financial information thereof to an account of the payee regarding to the financial information thereof through the financial institution network 50 for processing the financial transaction between the payer and the payee.

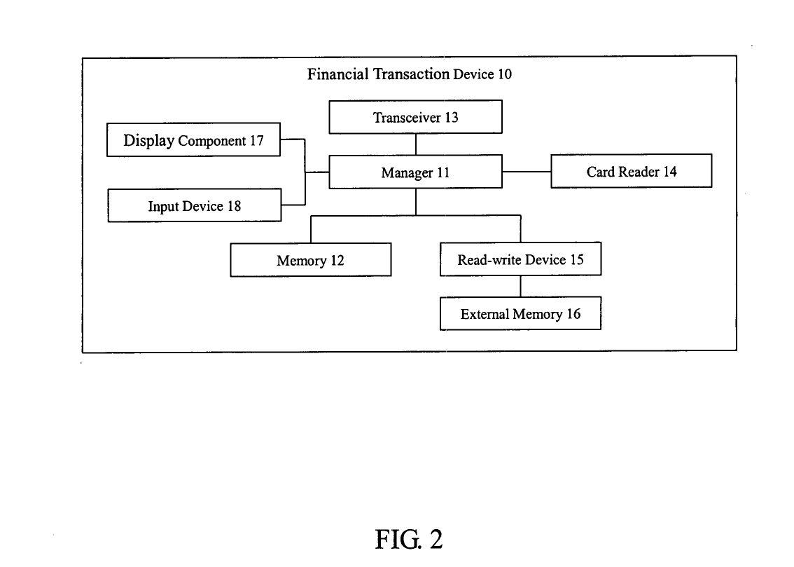

Referring to FIG. 2, the financial transaction device 10 comprises:

a manager 11 for managing and encrypting;

a card reader 14 connected with the manager 11, wherein the card reader 14 reads financial information from a financial card;

a transceiver 13 connected with the manager 11, wherein the transceiver 13 is communicatively linked with the management control 30 and other financial transaction devices 10.

Referring to FIG. 2, the financial transaction device 10 further comprises a display component 17 and an input device 18, both of which connected with the managed 1. The display component 17 is used to display financial information of financial cards, financial transaction information and so on. The input device 18 is used to input passwords, codes and any other information required in the financial transaction procedures.

The manager 11 encrypts the financial information and the transceiver 13 sends the encrypted financial information to the management control 30 and/or to other financial transaction devices 10, wherein the transceiver 13 receives encrypted financial information from other financial transaction devices 10.

In a preferred embodiment of the present invention, each piece of information is encrypted by the manager before being sent by the transceiver. Hence, when the financial information of the payer is sent to the payee, as this financial information has already been encrypted, the payee could not obtain the correct financial information of the payer, the pay's financial information is still safe. Hence, the financial information of the payer, the financial information of the payee, and payment amount of the financial transaction can be consolidated in the financial transaction device 10 of the payer or of the payee to generate payment information. Hence, the financial information of the payer is sent by the financial transaction device 10 of the payer to the financial transaction device 10 of the payee and is consolidated with the financial information of the payee and the payment amount in the financial transaction device 10 of the payee to generate the payment information, or the financial information of the payee is sent by the financial transaction device 10 of the payee to the financial transaction device 10 of the payer and is consolidated with the financial information of the payer and the payment amount in the financial transaction device 10 of the payer to generate the payment information.

However, in a preferred embodiment of the present invention, the financial information of the payer, the financial information of the payee, and payment amount of the financial transaction can be consolidated in the financial transaction device 10 of the payer to prevent any potential leaking of the personal information of the payer.

Referring to FIG. 2, the financial transaction device 10 further comprises a memory 12 connected with the manager 11, wherein the memory 12 stores financial transaction records therein. With the memory 12, the holder of the financial transaction device 10 could review any financial transaction at any time and make a management.

In a preferred embodiment, the financial transaction device 10 further comprises a read-write device 15 connected with the manager 11, wherein the read-write device 15 reads financial information stored in an external memory 16 and transmits the financial information to the manager. As a result, the holder of the financial transaction device 10 does not need to carry a plurality of financial cards and is worried to lose them. The holder only needs to use an external memory 16 with encrypted financial information of these financial cards. As the financial information is encrypted, it is very safe to carry such external memory 16. And even if this external memory 16 is lose, the holder could easily copy the financial information from the financial cards into another external memory 16 and encrypt the financial information to keep safe.

Meanwhile, the manager 11 manages financial transaction records stored in the memory 12 to be copied to an external memory 16 with the read-write device 15.

The financial card mentioned in this present invention includes credit card, debit card, ATM card, charge card, bank card and other cards provided by financial institution and used for paying.

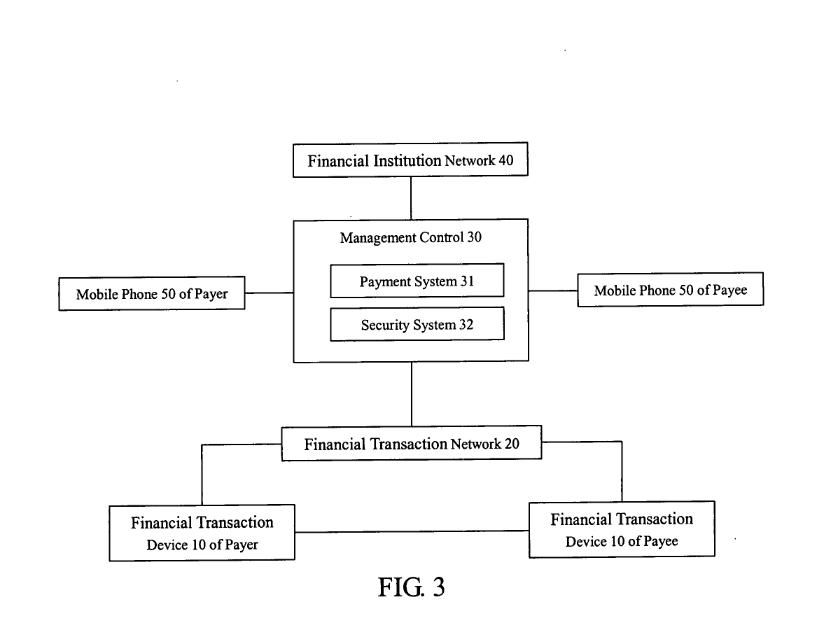

Referring to FIG. 3, the management control 30 comprises a payment system 31 and a security system 32. The payment system 31 receives the payment information from the financial transaction device 10. And the security system 32 records mobile phone numbers of holders of the financial transaction devices and relates each financial transaction device to corresponding mobile phone number to form a communication channel. Hence, a plurality of mobile phones 50 are communicated with the security system 32 as illustrated in FIG. 3. These mobile phones 50 are used to keep the financial transaction and financial information safe. This will be introduced later.

Referring to FIG. 3, the payment system 31 requests a bank of the payer regarding to the financial information thereof to transact the payment amount from the account of the payer to the account of the payee through the financial institution network 50.

A lot of financial cards, such as credit cards, debit cards and bank cards have codes predetermined by the card holder to keep the account of these cards safe. When use these cards, the corresponding codes are always required to protect the card holder's benefit. When use the system of the present invention, these codes are also required in the financial transaction procedure. Hence, when the bank of the payer requests a code to process the financial transaction, the payment system 31 sends the request to the financial transaction device 10 of the payer, and the financial transaction device 10 of the payer obtains the code from the payer and sends the code to the payment system 31, which sends the code to the bank of the payer through the financial institution network 50 to process the financial transaction.

Generally, these codes are a serial of numbers or letters or characters, all of which could be inputted into the financial transaction device 10 by the input device 18. However, sometimes, the codes might be fingerprints, holder's face or other forms of codes. Hence, the financial transaction device 10 of the present invention could further comprises a fingerprint scanner, a cam or any other adopted devices to satisfy these necessary.

After a financial transaction is completed, the payment system 31 sends a payment report to the financial transaction devices of the payer and the payee, both of which make a record of the payment therein respectively. As a result, the financial transaction records will be obtained and stored in the financial transaction device 10.

The security system 32 records mobile phone numbers of holders of the financial transaction devices 10 and relates each financial transaction device 10 to corresponding mobile phone number to form a communication channel.

When payment information is sent to the payment system 31, the security system 32 will sends a report to a mobile phone 50 of the payer regarding to the payment information. As a result, this payer will be reminded of this payment to avoid illegal using of his cards.

For better protection and prevention, when payment information is sent to the payment system 31, the security system 32 sends a password to a mobile phone 50 of the payer regarding to the payment information. And only when the password is sent back to the security system 32 by the financial transaction device 10 of the payer, and only when the password sent back to the security system 32 is the same as that sent to the mobile phone 50, the payment system 31 will process the financial transaction. With the use of password, the illegal use of the financial cards and financial transaction devices 10 will be prevented.

When the financial transaction device 10 with or without financial cards therein is lose, the benefit of the holder of the financial transaction device 10 might be hurt. In order to avoid this situation, the financial transaction device 10 of the present invention could be frozen by the holder. The security system 31 records holder information of holders of the financial transaction devices 10 that when a request for freezing a financial transaction device together with holder information thereof is received by the security system 32 and the holder information is confirmed the same with that recorded in the security system 32, the security system 32 will sends an order to the financial transaction device 10 to freeze the financial transaction device 10.

The system mentioned above is used to process financial transaction, and the method thereof will be illustrated below.

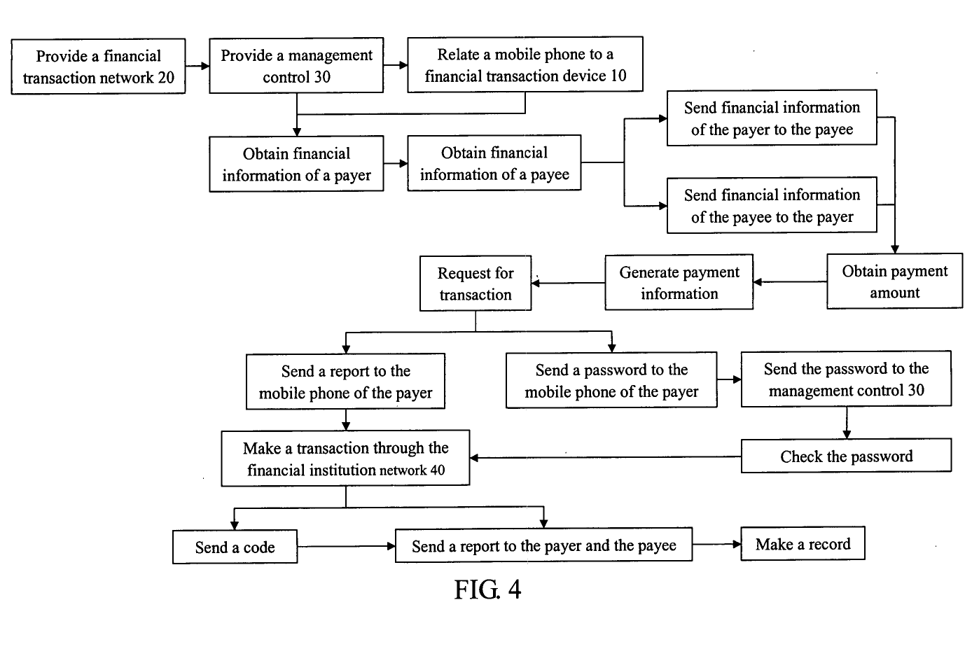

FIG. 4 illustrates a method of processing financial transaction, which comprises the steps of:

(a) providing a financial transaction network 20 and a management control 30;

(b) obtaining financial information of a payer and obtaining financial information of a payee;

(c) consolidating the financial information of the payer, the financial information of the payee and a payment amount of the financial transaction to generate a payment information;

(d) sending a request for financial transaction together with the payment information to the management control 30 through the financial transaction network 20;

(e) transacting the payment from an account of the payer regarding to the financial information thereof to an account of the payee regarding to the financial information thereof through a financial institution network 40.

In a preferred embodiment, the step (a) further comprises steps of:

providing a financial transaction network 20;

providing a management control 30 comprising a payment system 31 and a security system 32;

recording mobile phone numbers of holders of the financial transaction devices 10 and relating each financial transaction device 10 to corresponding mobile phone number to form a communication channel.

In a preferred embodiment, in the step (b), the financial information of the payer is obtained by a financial transaction device 10 of the payer and the financial information of the payee is obtained by a financial transaction device 10 of the payee.

In the step (b), the financial information is red from a financial card by a card reader 14 of the financial transaction device 10. As mentioned above, the financial card includes credit card, debit card, ATM card, charge card, bank card and other cards provided by financial institution and used for paying.

Optionally, the financial information is red from an external memory 16 with financial information stored therein by a read-write device 15 of the financial transaction device 10.

As mentioned above, the consolidation of the financial information of the payer, the financial information of the payee and a payment amount could be done in the financial transaction device 10 of the payer or of the payee. However, in a preferred embodiment, the step (c) further comprise steps of:

encrypting the financial information of the payee;

sending the encrypted financial information of the payee from the financial transaction device 10 of the payee to the financial transaction device 10 of the payer;

inputting payment amount of the financial transaction into the financial transaction device 10 of the payer;

consolidating the financial information of the payer, the financial information of the payee, and payment amount of the financial transaction;

generating a payment information.

Here, the consolidation is done in the financial transaction device 10 of the payer to prevent any potential risk.

The steps mentioned above could be used to implement the financial transaction, however, the security of the financial transaction should also be considered in the financial transaction procedure.

Referring to FIG. 4, the method further comprises a step for security between the steps (d) and (e), wherein the step for security comprises steps of:

sending a password to a mobile phone 50 of the payer regarding to the payment information by the security system 32;

inputting the password sent to the mobile phone 50 into the financial transaction device 10 of the payer;

sending the password back to the security system 32 by the financial transaction device 10 of the payer;

checking if password sent back is the same as that sent to the mobile phone 50 by the security system 32.

If so, processing the step (e).

If the password sent back is different from that sent to the mobile phone, the step for security further comprises step of sending an error report to the mobile phone 50 of the payer regarding to the payment information by the security system 32.

Besides, a report could be sent to the mobile phone to remind the holder of the financial transaction instead of the password. The method further comprises a step for security between the steps (d) and (e), wherein the step for security comprises step of sending a report to a mobile phone 50 of the payer regarding to the payment information by the security system 32.

As mentioned above, the codes are always required when using credit cards, debit cards, bank cards and so on. Hence, the step (e) further comprises steps of:

requesting a bank of the payer regarding to the financial information thereof to transact the payment amount from the account of the payer to the account of the payee through the financial institution network 40 by the payment system 31;

if the bank of the payer request for a code to process the financial transaction, sending the request to the financial transaction device 10 of the payer by the payment system 31;

inputting a code into the financial transaction device 10 of the payer and sending the code to the payment system 31;

sending the code to the bank of the payer to process the financial transaction;

transacting the payment from an account of the payer regarding to the financial information thereof to an account of the payee regarding to the financial information thereof through a financial institution network 50.

Referring to FIG. 4, the method further comprises a step (f) for recording after the step (e). The step (f) comprises steps of:

sending reports to the financial transaction devices 10 of the payer and the payee by the payment system 31;

making financial transaction records in the financial transaction devices 10 of the payer and the payee.

Here, the financial transaction records might be stored in the memory of the financial transaction device 10.

In order to keep the financial transaction safe and protect the benefit of the holder of the financial transaction device 10, the method further comprises a step for freezing, which comprises steps of:

recording holder information of holders of the financial transaction devices 10 in the security system 32;

sending a request for freezing a financial transaction device 10 together with holder information thereof to the security system 32;

checking if the holder information is the same with that recorded in the security system 32;

if so, sending an order to the financial transaction device 10 to freeze the financial transaction device 10 by the security system 32.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for processing financial transaction, comprising two or more financial transaction devices for at least a payer and a payer, a management control, and a financial transaction network linking said financial transaction devices with said management control, wherein said financial transaction devices of said payer and said payee are communicatively linked with each other and obtain financial information of said payer and said payee respectively, wherein said financial information of said payer, said financial information of said payee, and payment amount of said financial transaction are consolidated in said financial transaction devices to generate a payment information, which is sent together with a request for financial transaction by said financial transaction devices to said management control, wherein said management control transacts said payment from an account of said payer regarding to said financial information thereof to an account of said payee regarding to said financial information thereof through said financial institution network for processing said financial transaction between said payer and said payee.

2. The system, as recited in claim 1, wherein said financial information of said payer is sent by said financial transaction device of said payer to said financial transaction device of said payee and is consolidated with said financial information of said payee and said payment amount in said financial transaction device of said payee to generate said payment information, or said financial information of said payee is sent by said financial transaction device of said payee to said financial transaction device of said payer and is consolidated with said financial information of said payer and said payment amount in said financial transaction device of said payer to generate said payment information.

3. The system, as recited in claim 1, wherein said management control comprises a payment system which receives said payment information from said financial transaction device, wherein said payment system requests a bank of said payer regarding to said financial information thereof to transact said payment amount from said account of said payer to said account of said payee through said financial institution network.

4. The system, as recited in claim 2, wherein said management control comprises a payment system which receives said payment information from said financial transaction device, wherein said payment system requests a bank of said payer regarding to said financial information thereof to transact said payment amount from said account of said payer to said account of said payee through said financial institution network.

5. The system, as recited in claim 4, wherein when said bank of said payer requests a code to process said financial transaction, said payment system sends said request to said financial transaction device of said payer, and said financial transaction device of said payer obtains said code from said payer and sends said code to said payment system, which sends said code to said bank of said payer through said financial institution network to process said financial transaction.

6. The system, as recited in claim 5, wherein said payment system sends a payment report to said financial transaction devices of said payer and said payee, both of which make a record of said payment therein respectively.

7. The system, as recited in claim 4, wherein said management control further comprises a security system, which records mobile phone numbers of holders of said financial transaction devices and relates each financial transaction device to corresponding mobile phone number to form a communication channel.

8. The system, as recited in claim 7, wherein when payment information is sent to said payment system, said security system sends a report to a mobile phone of said payer regarding to said payment information.

9. The system, as recited in claim 7, wherein when payment information is sent to said payment system, said security system sends a password to a mobile phone of said payer regarding to said payment information, and only when said password is sent back to said security system by said financial transaction device of said payer, said payment system processes said financial transaction.

10. The system, as recited in claim 8, wherein when payment information is sent to said payment system, said security system sends a password to a mobile phone of said payer regarding to said payment information, and only when said password is sent back to said security system by said financial transaction system of said payer, said payment system processes said financial transaction.

11. The system, as recited in claim 7, wherein said security system records holder information of holders of said financial transaction devices that when a request for freezing a financial transaction device together with holder information thereof is received by said security system and said holder information is confirmed the same with that recorded in said security system, said security system sends an order to said financial transaction device to freeze said financial transaction device.

12. The system, as recited in claim 10, wherein said security system records holder information of holders of said financial transaction devices that when a request for freezing a financial transaction device together with holder information thereof is received by said security system and said holder information is confirmed the same with that recorded in said security system, said security system sends an order to said financial transaction device to freeze said financial transaction device.

13. The system, as recited in claim 1, wherein at least one of said financial transaction devices comprises:
a manager for managing and encrypting;
a card reader connected with said manager, wherein said card reader reads financial information from a financial card; and
a transceiver connected with said manager, wherein said transceiver is communicatively linked with said management control and other financial transaction devices, wherein said manager encrypts said financial information and said transceiver sends said encrypted financial information to said management control and/or to other financial transaction devices, wherein said transceiver receives encrypted financial information from other financial transaction devices.

14. The system, as recited in claim 2, wherein at least one of said financial transaction devices comprises:
a manager for managing and encrypting;
a card reader connected with said manager, wherein said card reader reads financial information from a financial card; and
a transceiver connected with said manager, wherein said transceiver is communicatively linked with said management control and other financial transaction devices, wherein said manager encrypts said financial information and said transceiver sends said encrypted financial information to said management control and/or to other financial transaction devices, wherein said transceiver receives encrypted financial information from other financial transaction devices.

15. The system, as recited in claim 14, wherein said financial transaction device further comprises a display component and an input device, both of which connected with said manager.

16. The system, as recited in claim 15, wherein each piece of information is encrypted by said manager before being sent by said transceiver.

17. The system, as recited in claim 16, wherein each said financial transaction device further comprises a memory connected with said manager, wherein said memory stores financial transaction records therein.

18. The system, as recited in claim 17, wherein each said financial transaction device further comprises a read-write device connected with said manager, wherein said read-write device reads financial information stored in an external memory and transmits said financial information to said manager, wherein said manager manages financial transaction records stored in said memory to be copied to an external memory with said read-write device.

19. The system, as recited in claim 18, wherein said financial card is selected from a group consisting of credit card, debit card, ATM card, charge card, bank card, and card provided by financial institution to be used for paying.

20. The system, as recited in claim 12, wherein when said bank of said payer requests a code to process said financial transaction, said payment system sends said request to said financial transaction device of said payer, and said financial transaction device of said payer obtains said code from said payer and sends said code to said payment system, which sends said code to said bank of said payer through said financial institution network to process said financial transaction.

21. The system, as recited in claim 20, wherein said payment system sends a payment report to said financial transaction devices of said payer and said payee, both of which make a record of said payment therein respectively.

22. The system, as recited in claim 21, wherein at least one of said financial transaction devices comprises:
a manager for managing and encrypting;
a card reader connected with said manager, wherein said card reader reads financial information from a financial card;
a transceiver connected with said manager, wherein said transceiver is communicatively linked with said management control and other financial transaction devices; and
a display component and an input device, both of which connected with said manager, wherein said manager encrypts said financial information and said transceiver sends said encrypted financial information to said management control and/or to other financial transaction devices, wherein said transceiver receives encrypted financial information from other financial transaction devices.

23. The system, as recited in claim 22, wherein each piece of information is encrypted by said manager before being sent by said transceiver.

24. The system, as recited in claim 23, wherein said financial transaction device further comprises a memory connected with said manager, wherein said memory stores financial transaction records therein.

25. The system, as recited in claim 24, wherein said financial transaction device further comprises a read-write device connected with said manager, wherein said read-write device reads financial information stored in an external memory and transmits said financial information to said manager, wherein said manager manages financial transaction records stored in said memory to be copied to an external memory with said read-write device.

26. The system, as recited in claim 25, wherein said financial card is selected from a group consisting of credit card, debit card, ATM card, charge card, bank card, and card provided by financial institution to be used for paying.

27. A method of processing financial transaction, comprising steps of:
(a) providing a financial transaction network and a management control;
(b) obtaining financial information of a payer and obtaining financial information of a payee;
(c) consolidating said financial information of said payer, said financial information of said payee and a payment amount of said financial transaction to generate a payment information;
(d) sending a request for financial transaction together with said payment information to said management control through said financial transaction network; and
(e) transacting said payment from an account of said payer regarding to said financial information thereof to an account of said payee regarding to said financial information thereof through a financial institution network.

28. The method, as recited in claim 27, wherein in said step (b), said financial information of said payer is obtained by a financial transaction device of said payer and said financial information of said payee is obtained by a financial transaction device of said payee.

29. The method, as recited in claim 28, wherein in said step (b), said financial information is red from a financial card by a card reader of said financial transaction device.

30. The method, as recited in claim 29, wherein said financial card is selected from a group consisting of credit card, debit card, ATM card, charge card, bank card, other cards provided by financial institution to be used for paying.

31. The method, as recited in claim 29, wherein said financial information is red from an external memory with financial information stored therein by a read-write device of said financial transaction device.

32. The method, as recited in claim 28, wherein said step (c) further comprises the steps of:
encrypting said financial information of said payee;
sending said encrypted financial information of said payee from said financial transaction device of said payee to said financial transaction device of said payer;
inputting payment amount of said financial transaction into said financial transaction device of said payer;
consolidating said financial information of said payer, said financial information of said payee, and payment amount of said financial transaction; and
generating a payment information.

33. The method, as recited in claim 30, wherein said step (c) further comprises the steps of:
encrypting said financial information of said payee;
sending said encrypted financial information of said payee from said financial transaction device of said payee to said financial transaction device of said payer;
inputting payment amount of said financial transaction into said financial transaction device of said payer;
consolidating said financial information of said payer, said financial information of said payee, and payment amount of said financial transaction; and
generating a payment information.

34. The method, as recited in claim 28, wherein said step (a) further comprises steps of:
providing a financial transaction network;
providing a management control comprising a payment system and a security system; and
recording mobile phone numbers of holders of said financial transaction devices and relating each financial transaction device to corresponding mobile phone number to form a communication channel.

35. The method, as recited in claim 34, further comprises a step for security between said steps (d) and (e), wherein said step for security comprises the steps of:
sending a password to a mobile phone of said payer regarding to said payment information by said security system;
inputting said password sent to said mobile phone into said financial transaction device of said payer;
sending said password back to said security system by said financial transaction device of said payer;
checking if password sent back is the same as that sent to said mobile phone by said security system; and
if so, processing said step (e).

36. The method, as recited in claim 35, wherein when password sent back is different from that sent to said mobile phone, said step for security further comprises the step of:
sending an error report to said mobile phone of said payer regarding to said payment information by said security system.

37. The method, as recited in claim 34, between said step (d) and step (e), further comprising a security step of sending a report to a mobile phone of said payer regarding to said payment information by said security system.

38. The method, as recited in claim 34, wherein said step (e) further comprises the steps of:
requesting a bank of said payer regarding to said financial information thereof to transact said payment amount from said account of said payer to said account of said payee through said financial institution network by said payment system;
when said bank of said payer request for a code to process said financial transaction, sending said request to said financial transaction device of said payer by said payment system;
inputting a code into said financial transaction device of said payer and sending said code to said payment system;
sending said code to said bank of said payer to process said financial transaction; and
transacting said payment from an account of said payer regarding to said financial information thereof to an account of said payee regarding to said financial information thereof through a financial institution network.

39. The method, as recited in claim 34, after said step (e), further comprising the steps of:
sending reports to said financial transaction devices of said payer and said payee by said payment system; and
making financial transaction records in said financial transaction devices of said payer and said payee.

40. The method, as recited in claim 34, further comprising the freezing steps of:
recording holder information of holders of said financial transaction devices in said security system;
sending a request for freezing a financial transaction device together with holder information thereof to said security system;
checking if said holder information is the same with that recorded in said security system; and
if so, sending an order to said financial transaction to freeze said financial transaction by said security system.

41. The method, as recited in claim 33, wherein said step (a) further comprises the steps of:
providing a financial transaction network;
providing a management control comprising a payment system and a security system; and
recording mobile phone numbers of holders of said financial transaction devices and relating each financial transaction device to corresponding mobile phone number to form a communication channel.

42. The method, as recited in claim 41, between said steps (d) and (e), further comprising the security steps of:
sending a password to a mobile phone of said payer regarding to said payment information by said security system;
inputting said password sent to said mobile phone into said financial transaction device of said payer;
sending said password back to said security system by said financial transaction device of said payer;
checking if password sent back is the same as that sent to said mobile phone by said security system;
if so, processing said step (e); and
if not, sending an error report to said mobile phone by said security system.

43. The method, as recited in claim 42, wherein said step (e) further comprises the steps of:
requesting a bank of said payer regarding to said financial information thereof to transact said payment amount from said account of said payer to said account of said payee through said financial institution network by said payment system;
when said bank of said payer request for a code to process said financial transaction, sending said request to said financial transaction device of said payer by said payment system;
inputting a code into said financial transaction device of said payer and sending said code to said payment system;
sending said code to said bank of said payer to process said financial transaction; and
transacting said payment from an account of said payer regarding to said financial information thereof to an account of said payee regarding to said financial information thereof through a financial institution network.

44. The method, as recited in claim 43, after said step (e), further comprising the steps of:
sending reports to said financial transaction devices of said payer and said payee by said payment system; and
making financial transaction records in said financial transaction devices of said payer and said payee.

45. The method, as recited in claim 44, further comprising the freezing steps of:
recording holder information of holders of said financial transaction devices in said security system;
sending a request for freezing a financial transaction device together with holder information thereof to said security system;
checking if said holder information is the same with that recorded in said security system; and
if so, sending an order to said financial transaction to freeze said financial transaction by said security system.
